(19) United States
(12) Patent Application Publication
(10) Pub. No.: US 2025/0062111 A1
(43) Pub. Date: Feb. 20, 2025

(54) MULTI-REFLECTION MASS SPECTROMETER

(71) Applicant: Thermo Fisher Scientific (Bremen) GmbH, Bremen (DE)

(72) Inventors: Dmitry Grinfeld, Bremen (DE); Hamish Stewart, Bremen (DE); Christian Hock, Bremen (DE)

(73) Assignee: Thermo Fisher Scientific (Bremen) GmbH, Bremen (DE)

(21) Appl. No.: 18/803,184

(22) Filed: Aug. 13, 2024

(30) Foreign Application Priority Data
Aug. 15, 2023 (GB) 2312458.9

(51) Int. Cl. H01J 49/40; H01J 49/00

(52) U.S. Cl. CPC H01J 49/406; H01J 49/0009

(57) ABSTRACT

A multi-reflection time of flight mass spectrometer comprises a mass analyser with opposing mirror electrodes and a focal plane correction electrode. Each mirror electrode is elongated generally along a drift direction. The focal plane correction electrode extends along at least a portion of the drift direction in or adjacent the space between the mirror electrodes. Ions are injected into the mirror electrodes and an electrical potential provided to the mirror electrodes reflects the ions in the resulting ion beam and causes the ions to follow a zig zag path as they drift along the mirror electrodes. An electrical potential is also provided to the focal plane correction electrode to set the focal plane position of the ion beam to coincide with a detector surface of an ion detector placed at the end of the ions' path.

### CROSS REFERENCE TO RELATED APPLICATION

This application claims priority from application GB 2312458.9, filed Aug. 15, 2023. The entire disclosure of application GB 2312458.9 is incorporated herein by reference.

### FIELD OF INVENTION

This invention relates to the field of mass spectrometry, in particular high mass resolution time-of-flight mass spectrometry and electrostatic trap mass spectrometry utilizing multi-reflection techniques for extending the ion flight path.

### BACKGROUND OF THE INVENTION

Various arrangements are known that utilise multi-reflections to extend the flight path of ions within mass spectrometers. Flight path extension is desirable to increase time-of-flight separation of ions within time-of-flight (ToF) mass analysers as it increases the ability to distinguish small mass differences between ions.

An example of a multi-reflection time-of-flight (MR-ToF) mass analyser is to be found in WO2013/110587. Two parallel opposing mirror electrodes are elongated in a drift direction (the y direction). Ions are extracted from an ion trap and injected into the mirror electrodes and the ions are then reflected between the mirror electrodes (the z direction) while also drifting relatively slowly along the extended length of the mirror electrodes in the drift direction. Hence, the ions follow a zigzag flight path through the mass analyser.

Furthermore, the mirror electrodes are tilted by an angle Q relative to one another such that their separation in the z direction decreases as they extend in the drift direction. Ions starting oscillations between the opposing mirror electrodes also drift in the Y direction due to the initial inclination at which the ions were injected into the mirror electrodes. The mirror convergence tilt angle @ causes the trajectory inclination angle to decrease by 20 upon every oscillation which includes two reflections. As a result, the drift direction is eventually reversed such that the ions travel back through the mirror electrodes to be detected by an ion detector positioned adjacent the ion trap.

However, tilted mirror electrodes cause ToF aberrations. This is because not all ions follow a common path through the mirror electrodes. The finite spread in the beam injection angle results in some ions drifting further down the mirror electrodes than other ions. Advantageously, reflecting the ions to travel back along the mirror electrodes means that the ions are spatially focused once more when they arrive at the ion detector. However, a temporal aberration is introduced because the period of oscillation of the ions decreases as a function of the distance along the drift direction as a result of the decreasing separation between the mirror electrodes.

These ToF aberrations are rectified by modifying the average velocity of the ions as they cross between the mirror electrodes, as a function of drift position y, using stripe electrodes. The stripe electrodes run along the space between the mirror electrodes and are shaped to have a varying width with drift position y, so that the proportion of the flight path between the mirrors at the potential of the stripe electrodes varies along the drift position. Consequently, the average potential and thus average ion velocity changes as a function of the distance along the mirror electrodes. The average electric field potential increases along the drift direction such that ions travel more slowly the further they drift along the mirror electrodes. This will cause the period of oscillation to increase as a function of the distance along the drift direction, thereby mitigating the decrease in period due to the converging mirror electrodes.

The voltage placed on the stripe electrodes can be adjusted to create an electric field that cancels the ToF aberrations resulting from the angular spread in the ions injected into the mirror electrodes. This correction assists in creating a substantially equal average oscillation time over multiple oscillations of the ions between the opposing mirror electrodes even though the distance between the mirrors changes.

An alternative MR-ToF analyser is described in US2020/0243322. The analyser comprises mirror electrodes that are parallel rather than tilted, and so ions progress along the length of the mirror electrodes with a constant drift velocity and are detected at the opposite end of the mirror electrodes to the ion trap from which they are injected. US2020/0243322 includes stripe electrodes, although for a different reason than WO2013/110587 as there is no need to correct ToF aberrations arising from tilted mirror electrodes. Instead, a first pair of curved stripe electrodes are used to correct for any curvature in the mirror electrodes. A second pair of stripe electrodes are used to correct for any misalignment between the mirror electrodes.

To achieve high resolution, the mirror electrodes must be made and installed with very high precision, namely to tolerances as low as tens of microns. Small mechanical errors degrade the focal quality and/or tilt the ions' focal plane relative to the detector surface, collapsing the achievable resolving power. Also, the voltages applied to the mirror electrodes must be extremely stable, to the level of parts per million. These very stable voltages are required such that there is no jitter when summing up multiple repetitions of the mass analyser, and over longer periods to maintain the mass calibration of the mass analyser. Mass calibration is required to mitigate against the impact of mechanical error. Calibration involves tuning the voltages applied to the mirror electrodes, for example to at least align the focal distance of the ion beam to coincide with the detector surface.

The requirement to provide precise voltages, at high voltage levels, that remain highly stable typically requires high levels of filtering and damping, and hence the use of substantial capacitance. Consequently, the power supplies respond slowly to a change of setting, and cannot cope with changes within a scan and often struggle to provide a seamless change between scans, for normal repetition rates in the region of 100 Hz. This means delays are required when switching between modes of operation where the focal plane needs to be adjusted.

An additional problem faced by ToF analysers is that as the number of ions in the ToF analyser increase as a peak is scanned, the resolution falls precipitously. This is because the increase in ion density gives rise to space charge effects that cause the focal plane position to shift. The mirror electrode voltages may be hardened to counter the shift in the focal plane and mitigate the losses, but this comes at the cost of maximum resolving power. Whilst a compromise value may be found, it would be better to be able to switch rapidly between space charge tolerance levels based on the likely intensities of the measured peaks, or to get a wider dynamic range of space charge tolerance by combining several spectra. Unfortunately, as noted above, the large capacitances present in power supplies means that the mirror electrode voltages cannot be adjusted on such a short (low millisecond) timeframe.

A special mode of operation of multi-reflection ToF analysers termed “Zoom Mode” was described by Verenchikov et al, in the Journal of Applied Solution Chemistry and Modelling, 2017, volume 6, pages 1-22. A deflector placed early in the ion path through the mirror electrodes is switched on to supply a trapping voltage that forces ions to undergo multiple passes up and down the mirror electrodes. The greatly extended flight paths provided vastly increased resolution, up to 500,000, but induce, as the name suggests, a severe narrowing of the mass range that can be scanned.

A major disadvantage of zoom mode is that the ToF focal plane position shifts with number of drift passes. This means that it is difficult to switch rapidly between zoom mode and regular mode, as mirror electrode voltage shifts are not responsive enough to keep up with the switching instrument operation. This cripples many potential applications, such as mixing unambiguous full MS or MS/MS spectra with a high-resolution zoom shot of a target region, for example for the isobaric TMT reporter ions proposed by McAlister et al (Anal. Chem., 2012, volume 84, pages 7469-7478).

### SUMMARY

According to a first aspect, there is provided a method of mass spectrometry in a multi-reflection time of flight mass spectrometer comprising a mass analyser with two mirror electrodes and a focal plane correction electrode. Each mirror electrode is elongated generally along a drift direction (y), each mirror electrode opposing the other in a z direction, the z direction being orthogonal to y. The focal plane correction electrode extends along at least a portion of the drift direction in or adjacent the space between the mirror electrodes.

The method comprises injecting ions into the mirror electrodes and providing an electrical potential to the mirror electrodes that reflects the ions in the resulting ion beam and causes the ions to follow a zig zag path as they drift along the mirror electrodes. The method also comprises providing an electrical potential to the focal plane correction electrode to set the focal plane position of the ion beam to coincide with a detector surface of an ion detector placed at the end of the ions' path through the mirror electrodes.

The use of a focal plane correction electrode provides an advantageous way of adjusting the focal plane position of the ion beam. The focal plane correction electrode may fully correct or may partially correct the focal plane position of the ion beam to coincide with the detector surface of the ion detector. This avoids the problems of using the stable high voltage potential supply used to set the potential on the mirror electrodes that can provide only very slow response times. The focal plane correction electrode has a unique advantage in that it allows fine tuning of the focal plane position to be performed by a perturbation field requiring much lower potentials. For example, the focal plane correction electrode may be set to a potential close to ground. These smaller potentials may be varied rapidly, thereby avoiding any delays between scans. This also frees up the power supply to the mirror electrodes to supply fixed, unvarying voltages during a scan. This reduces the complexity and cost of the electronics required for the power supply. The electrical potential supplied to the focal plane correction electrode may have a value between ±150 V, or between ±100 V. A further advantage is that the low potential set means that the focal plane correction electrode then has very little influence on the ion reflection process, which means that the requirement for a very stable applied potential is very much more relaxed.

Optionally, the method comprises providing the electrical potential to the focal plane correction electrode to set the effective length of the ions' oscillations between the mirror electrodes such that the total effective path length of the ions causes the focal plane position of the ion beam to coincide with the detector surface of the ion detector.

The method may comprise adjusting the electrical potential to the focal plane correction electrode during a scan to mitigate the drift of the focal plane position of the ion beam away from the detector surface of the ion detector. The electrical potential provided to the focal plane correction electrode may be adjusted during a scan to mitigate the drift of the focal plane position of the ion beam away from the detector surface of the ion detector as a function of the number of ions in the mass analyser. This may be done to mitigate the change in space charge effects resulting from either an increase or decrease in the number of ions in the mass analyser. Use of the focal plane correction electrode allows rapid shifts in the focal plane position due to space charge effects to be compensated for just as quickly, which extends the dynamic range of the instrument.

Optionally, the method may comprise adjusting the electrical potential to the focal plane correction electrode between scans to mitigate the drift of the focal plane position of the ion beam away from the detector surface of the ion detector. The electrical potential provided to the focal plane correction electrode may be adjusted between scans to mitigate the drift of the focal plane position of the ion beam away from the detector surface of the ion detector as a function of the number of ions in the mass analyser. This may be done to mitigate the change in space charge effects resulting from either an increase or decrease in the number of ions in the mass analyser between the scans. A scan may be a zoom mode scan preceded by a scan that is not a zoom mode scan. The non-zoom mode scan may comprise ions completing one pass between the ion source and the ion detector. The zoom mode may comprise multiple passes of the ions between the ion source and the ion detector, i.e. with the ion beam being deflected back through the mirror electrodes multiple times before the ion beam is allowed to pass to the ion detector. Use of the focal plane correction electrode allows fast switching between normal and zoom modes, potentially even within a single scan, so that all ions are always in focus during both scans.

The mirror electrodes may be segmented into electrodes that extend in the y direction and are separated in the z direction. The method may include providing the electrical potential to the focal plane correction electrode by providing the electrical potential to an electrode of one of the mirror electrodes, wherein that electrode is the closest electrode to the space between the mirror electrodes. Alternatively, the method may include providing the electrical potential to a pair of electrodes of the mirror electrodes, wherein the pair of electrodes are the electrodes closest to the space between the mirror electrodes. In this way, the mirror electrodes may be used also to fulfil the function of the correction electrode. This means the mass analyser does not require any additional electrodes.

The mirror electrodes may be tilted at a tilt angle relative to one another such that the separation between the mirrors in the z direction decreases as the distance along the y direction increases. The mass analyser may also further comprise a time of flight correction electrode. The method may further comprise providing a further electrical potential to the time of flight correction electrode to correct a spread in the time of flight of ions along ions' path through the mirror electrodes caused by the tilt angle of the mirror electrodes. In such a case, providing the electrical potential to the focal plane correction electrode may comprise providing the electrical potential and the further electrical potential to the time of flight correction electrode. In this way, the time of flight correction electrode may be used also to fulfil the function of the focal plane correction electrode. This means the mass analyser does not require any additional electrodes.

The time of flight correction electrode may be supported by a carrier. Then, providing the electrical potential to the focal plane correction electrode may comprise providing the electrical potential and the further electrical potential to the time of flight correction electrode and providing the electrical potential to the carrier. Supplying the electrical potential to both the time of flight correction electrode and the carrier ensures that the potential difference between the time of flight correction electrode and the carrier is maintained, thereby preserving the time of flight correction applied by the time of flight correction electrode.

According to a second aspect, there is provided a method of calibrating a mass analyser in a multi-reflection time of flight mass spectrometer. The mass analyser comprises two mirror electrodes and a focal plane correction electrode. Each mirror electrode is elongated generally along a drift direction y), each mirror electrode opposes the other in a z direction, the z direction being orthogonal to y, and the focal plane correction electrode extends along at least a portion of the drift direction in or adjacent the space between the mirror electrodes.

The method comprises injecting ions into the mirror electrodes and providing an electrical potential to the mirror electrodes that reflects the ions in the resulting ion beam and causes the ions to follow a zig zag path as they drift along the mirror electrodes. The method also comprises providing a range of electrical potentials to the focal plane correction electrode, detecting the ions with a detector surface of an ion detector placed at the end of the ions' path through the mirror electrodes, and measuring the resolution of the mass analyser at each of a plurality of electrical potentials provided to the focal plane correction electrode.

This allows the optimal setting to be found for different scans. Different ions may be used to allow a table of settings to be compiled. Such a table may be used as a look up table for later operation of the mass spectrometer.

Optionally, measuring the resolution of the mass analyser at each of a plurality of electrical potentials provided to the focal plane correction electrode comprises measuring the width of a peak corresponding to number of ions as a function of the ions' m/z ratio. For example, the full width at half maximum may be measured.

According to a third aspect, there is provided a multi-reflection time of flight mass analyser comprising two mirror electrodes, each mirror electrode being elongated generally along a drift direction away from the ion injection point (y direction), each mirror electrode opposing the other in a z direction, and the z direction being orthogonal to the y direction. The mass analyser also comprises a focal plane correction electrode extending along at least a portion of the y direction in or adjacent the space between the mirror electrodes. The mass spectrometer also comprises a controller configured to cause the mass analyser to operate in accordance with the any of the methods described above.

Optionally, the two mirror electrodes are tilted at a tilt angle such that the separation between the mirrors in the z direction decreases as the distance along the y direction increases. The mass analyser may comprise an ion source and an ion detector both positioned at the same end of the mirror electrodes.

The width of the focal plane correction electrode may be substantially the same in the z direction along the length of the focal plane correction electrode in the y direction. The mass analyser may comprise a pair of focal plane correction electrodes placed on opposing sides of the ion beam's path through the mass analyser.

### LIST OF FIGURES

In order that the invention can be more readily understood, reference will now be made by way of example only, to the accompanying drawings in which:

FIG. 1 is a schematic representation of a prior art multi-reflection time-of-flight mass analyser;

FIG. 2 is a schematic representation of operation of a mass analyser in zoom mode;

FIG. 3 is a schematic representation of an embodiment of a multi-reflection time-of-flight mass analyser;

FIG. 4 is a schematic representation of a method of determining a potential to be applied to a focal plane correction electrode to optimise resolution;

FIG. 5 is a graph showing the variation of resolution with focal plane correction electrode potential;

FIG. 6 is a schematic representation of a further embodiment of a multi-reflection time-of-flight mass analyser; and

FIG. 7 is a schematic representation of a still further embodiment of a multi-reflection time-of-flight mass analyser.

### DETAILED DESCRIPTION

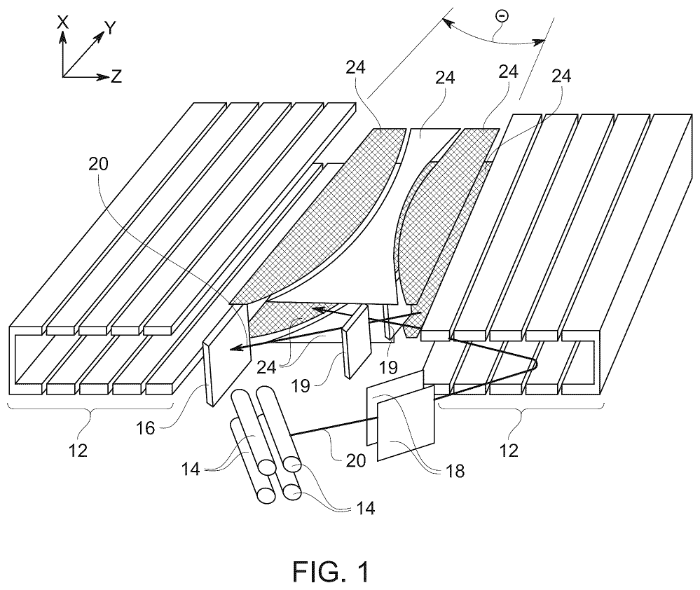

As discussed above, some designs of mass spectrometer utilise multi-reflections to extend the flight path of ions which is desirable as it increases time-of-flight separation of ions and hence resolution within the time-of-flight (ToF) mass analyser. FIG. 1 shows an example of a multi-reflection time-of-flight (MR-ToF) mass analyser 10. A pair of ion-optical mirrors are provided by two parallel opposing mirror electrodes 12 that are elongated in a drift direction (the y direction). Ions 20 are extracted from an ion trap 14 and injected into the mirror electrodes 12. The ions 20 are beam-shaped by lenses/deflectors 18 before being reflected from the first mirror electrode 12. The expanding ion beam 20 then meets a second deflector 19, which sets the final injection angle and collimates the ion beam 20 as best achievable. The ions 20 are then multiply reflected between the mirror electrodes 12 (the z direction) while also drifting relatively slowly along the extended length of the mirror electrodes 12 in the drift (y) direction. Hence, the ions 20 follow a zigzag flight path through the mass analyser 10.

Furthermore, the mirror electrodes 12 are tilted by an angle Θ relative to one another (typically around 0.05 degrees) such that their separation in the z direction decreases as they extend in the drift direction. The convergence angle Θ causes the trajectory inclination angle of the ions 20 to decrease by 20 upon every oscillation (each oscillation includes two reflections). As a result, the drift of the ions 20 is eventually reversed such that the ions 20 travel back through the mirror electrodes 12 to be detected by an ion detector 16 positioned adjacent the ion trap 14.

The ions 20 have a small spread of injection angles and so the ion beam 20 widens as it drifts along the mirror electrodes 12. Hence, the drift length of an ion along the mirror electrodes 12 varies depending upon that ion's injection angle: those ions 20 injected at relatively steep angles have lower velocity components in the y direction and so will drift less far along the mirror electrodes 12 than those injected at relatively shallow angles that have higher velocity components in the y direction. The small tilt angle Q acts to cause a spread in the time of flight of the ions 20 because ions 20 drifting further along the mirror electrodes 12 experience more of the narrowed gap between the mirror electrodes 12 than those ions 20 drifting less far. This causes differing times of flight for ions 20 having the same m/z ratio but with different injection angles, and hence a loss of resolution.

The spread in the time of flight of the ions 20 introduced by the tilted mirror electrodes 12 is addressed by adding a pair of correction electrodes 24 down the length of the drift dimension, with one correction electrode 24 located above the ion beam 20 and the other correction electrode 24 located below the ion beam 20. These correction electrodes 24 are referred to as ToF correction electrodes 24 hereinafter to reflect their function in correcting the spread in time of flight of the ions 20.

An edge of each ToF correction electrode 24 has a shape determined by a shape function S (y) corresponding to the spread in the time of flight to be corrected. The shape function may define the width of the ToF correction electrode 24 (in the z-direction) as a function of position along the drift (y) direction. The ToF correction electrodes 24 modify the electric field at a region where the ions 20 propagate and, therefore, cause additional drift deflection and time-of-flight perturbation to the ions 20. Moreover, the modification to the electric field can be set to counter the effect of the mirror electrodes' convergence, such that the ToF correction electrodes 24 ensure that all ions 20 have the same the time of flight from the ion trap 14 to the ion detector 16 regardless of any variation of the starting point y₀ and the initial drift velocity v₀=dy₀/dt.

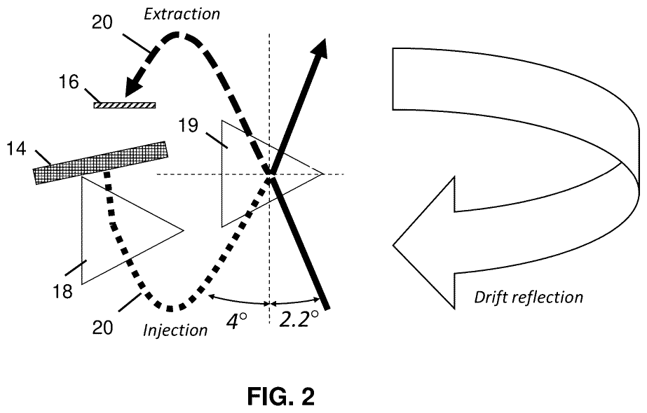

As briefly discussed in the background section, ToF mass analysers like that shown in FIG. 1 may be operated in a zoom mode. FIG. 2 shows schematically how this mode of operation works. Ions 20 are injected from the ion trap 14, through the deflector 18 and between the mirror electrodes 12 at a relatively high angle. After the first half oscillation, the ions 20 pass a second prism-shaped deflector 19 that reduces the injection angle by almost half. Oscillating ions 20 then drift up the elongate mirror electrodes' length and are turned back by the mirror electrodes' set tilt. By the time the ions 20 return to the second deflector 19, the voltage has been switched, e.g., from roughly −150V to a trapping voltage of roughly +350V, which causes the ions 20 to be reflected back down the length of the mirror electrodes 12 for a second pass. These reflections are continued until, after a desired number of passes, the deflector 19 is switched back to the injection/extraction voltage (e.g. roughly −150V) such that the ions 20 may pass and travel onward to the ion detector 16. For optimal resolution, the number of passes of the ions 20 is made to be an odd number because this allows the aberration induced by the deflector reflection to self-correct every repeat journey. By forcing the ions 20 to undergo multiple passes up and down the mirror electrodes 12, the ions' path length is greatly extended which provides vastly increased resolution within a much narrower mass range scan.

However, the focal plane position of the ions 20 shifts with the number of passes through the mirror electrodes 12. Consequently, switching in and out of zoom mode requires a large change in the voltage set on the mirror electrodes 12 to adjust the focal plane position. As described above, the large capacitance inherent in power supplies means that this switch cannot be made rapidly which cripples many potential applications, such as mixing unambiguous full MS or MS/MS spectra with a high-resolution zoom shot of a target region (for example for isobaric TMT reporter ions).

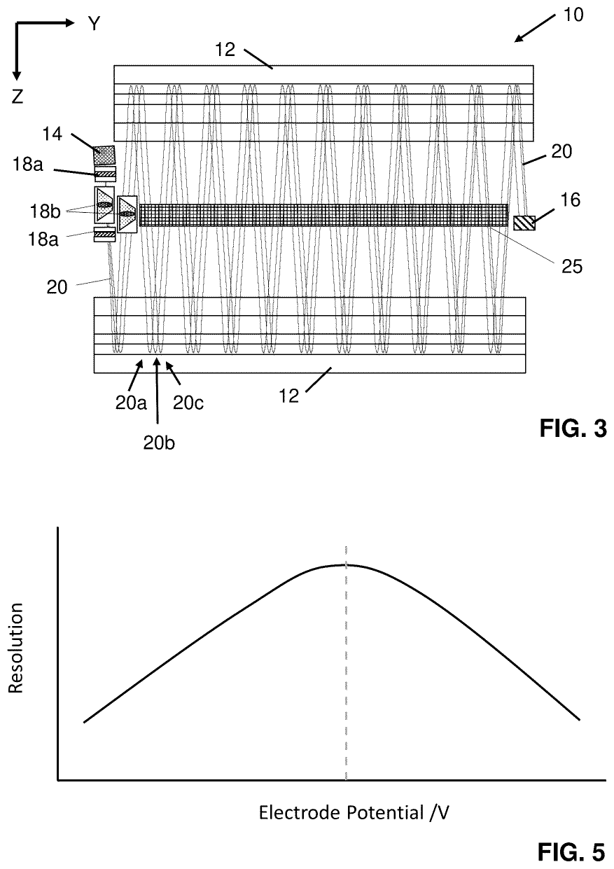

A ToF mass analyser 10 is shown in FIG. 3. The mass analyser 10 comprises parallel mirror electrodes 12 such that ions 20 make a single pass along the length of the mirror electrodes 12 as the ions 20 oscillate between the mirror electrodes 12. The ions 20 are injected from an ion trap 14 and pass thorough lenses/deflectors 18 where the ion beam 20 is beam-shaped before being reflected from the first mirror electrode 12. In some embodiments, including this embodiment, the lenses/deflectors 18 comprise a pair of out-of-plane lenses 18a and a pair of deflectors 18b that also provide drift focusing.

Three trajectories are shown for ion beam 20: 20a corresponds to the trajectory followed by ions 20 injected at the steepest injection angle, 20b corresponds to the middle central trajectory and 20c corresponds to the trajectory followed by ions 20 injected at the shallowest injection angle.

The mass analyser 10 also comprises a correction electrode, namely a flat stripe electrode 25 that, in use, is biased with an electrical voltage which affects the ions' oscillation times between the mirror electrodes 12 without deflecting the ions' trajectories spatially, thereby shifting the focal plane of the ion beam 20. This correction electrode 25 is referred to as a focal plane correction electrode 25 hereinafter to reflect its function in correcting the focal plane of the ion beam 20.

Even applying a relatively low voltage in the range ±100V to the focal plane correction electrode 25 substantially shifts the focal plane of the ion beam 20. Whilst FIG. 3 shows parallel mirror electrodes 12 and an ion beam 20 that is collimated by drift focusing lenses 18b, it is easy to see that a corresponding focal plane correction electrode 25 can be used in a tilted mirror mass analyser 10, like that shown in FIG. 1. The additional, focal plane electrode 25 may be nestled in the space between the existing pair of ToF correction electrodes 24. In any arrangement, a pair of focal plane correction electrodes 25 may be used with one focal plane correction electrode 25 on either side of the ion beam 20. The focal plane correction electrodes 25 can be a pair of metal plates mounted via insulation to an electrode carrier, typically itself a steel or aluminium structure. The vacuum chamber housing the mass analyser 10 itself could serve this purpose if fabricated with sufficiently accuracy. Alternatively, the focal plane correction electrodes 25 may be printed on a glass substrate, or PCB/ceramic PCB material.

The low voltage requirement of such a focal plane correction electrode 25 makes it suitable for fast voltage switching, so that the ion beam's focal plane may be adjusted on the low millisecond timescale, sufficient for shot-to-shot adjustment. This also makes it applicable for switching between zoom and regular operation modes for example, as well as rapid switching to accommodate quickly varying space charge tolerance levels caused as ion densities change rapidly as peaks are scanned.

The action of the focal plane correction electrode 25 modifies the effective distance between the two opposing mirror electrodes 12 when the ions 20 are accelerated or decelerated while travelling between the mirror electrodes 12 by the focal plane correction electrodes 25 placed both sides of the (yz) plane. The effective length W_{osc} of one oscillation is defined as the oscillation period T₀ times the nominal ion velocity v_{z}=\sqrt{2qUₐ/m} where Uₐ is the acceleration voltage, and m and q are the ion's mass and charge. As the oscillation period in the electrostatic field is proportional to \sqrt{m/q}, the effective oscillation length W_{osc}=T₀v_{z} is independent of m and q.

A focal plane correction electrode 25 of width wₛ placed between the mirror electrodes 12 and biased with a voltage u (|u|<<Uₐ) modifies the oscillation period T₀ by an amount

$$Δ {T}_{0} = 2 \frac{{w}_{s} \sqrt{m}}{\sqrt{2 q ( {U}_{a} - u )}} - 2 \frac{{w}_{s} \sqrt{m}}{\sqrt{2 {qU}_{a}}} ≅ \frac{{w}_{s}}{{v}_{z}} \frac{u}{{U}_{a}} .$$

The coefficient 2 reflects the fact that an ion 20 passes the focal plane correction electrode 25 two times per oscillation. Correspondingly, the effective oscillation length W_{OSC} is modified by an amount

$$Δ W ≅ Δ {T}_{0} {v}_{z} = {w}_{s} \frac{u}{{U}_{a}} .$$

Having K oscillations between the mirror electrodes 12 as the ions 20 travel from the ion trap 14 to the ion detector 16, the ToF focal plane location shifts by the amount

$${Kw}_{s} \frac{u}{{U}_{a}} .$$

By way of example, the number of oscillations may be K=25 and the mirror electrode's voltage may be Uₐ=4 kV. Then, a focal plane correction electrode 25 with a width wₛ=100 mm biased with a voltage u=±40V shifts the ToF focal plane position by

$$25 \times 100 mm \times \frac{\pm 40 V}{4000 V} = \pm 25 mm$$

which is sufficient to compensate for any space-charge induced defocusing. The width of the focal plane correction electrode 25 can be maximised to minimize the required voltage u.

As noted above, achieving a comparable shift of the ToF focal plane through adjusting the voltages placed on the mirror electrodes 12 is very slow. For example, stabilization on the new voltages takes up to several seconds. On the contrary, the low-voltage focal plane correction electrode 25 may operate at frequencies of several kHz. This makes it possible to adjust the ToF focal plane position during normal operation without requiring any delays.

There are several advantages to using the focal plane correction electrode 25 to correct the ToF focal plane position in addition to the stable high voltage supplies supplying the mirror electrodes 12 being very slow to change. For example, an arrangement that adjusts only the voltages supplied to the mirror electrodes 12 necessitates individually adjustable voltages for each mirror electrode 12, which is hugely expensive. With the present invention, the mirror electrodes 12 may be used to provide a rough tune using two stable voltages with a resistor chain, and then the focal plane correction electrode 25 may provide fine focal plane tuning.

Also, by switching the bias of the focal plane correction electrode 25 between scans, the mass analyser 10 may be tuned for optimum focusing of ion peaks containing different number of ions 20 and hence different amount of space charge. The main effect of space charge in intense peaks is a reduction in resolution which can normally be ameliorated by the same mirror electrode voltage tuning adjustments as alters focal plane position. Therefore, a series of scans may give the highest resolving powers consecutively to low abundant, medium abundant, and high abundant peaks (or in the reversed order), thus covering the full range of peaks in the mass spectrum. Energy acceptance limits of the mass analyser 10 also often mean that low m/z scans have a slightly different focal plane tune to higher m/z scans. The use of the focal plane correction electrode 25 allows rapid adjustment of the focal plane position between scans to correct the drift in the focal plane position.

A further advantage is to correct the large shift in ToF focal plane position seen in zoom mode where the flight path of the ions 20 is varied by sending the ions 20 along the mass analyser 10 repeatedly. Using the focal plane correction electrode 25 allows a rapid correction of the ToF focal plane position and can be done within ˜1 ms between scans.

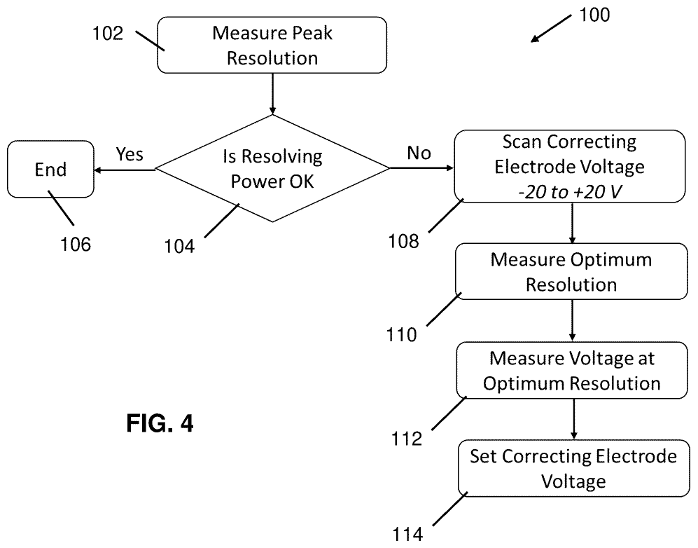

FIG. 4 shows a method 100 of determining a correction voltage to be applied to the focal plane correction electrode 25 to ensure that the focal plane of the ion beam 20 coincides with the ion detector 16 and thus optimise resolution.

The method 100 starts at 102 where the peak resolution is measured. This may be done by measuring the full width at half maximum of the peak within a single measurement, and a single peak contains many ions, usually ˜100. At 104, a determination is made as to whether the resolution is acceptable. If the resolution is found to be acceptable, the method ends at 106.

When the resolution is not found to be acceptable, the method continues to 108 where the optimal focal plane correction electrode voltage is calibrated by making a 1-dimensional scan of the voltage applied to the focal plane correction electrode 25, whilst measuring the full width at half maximum of a known ion peak such as an internal calibrant. This may be done by scanning the voltage applied to the focal plane correction electrode 25 by +20V about the voltage first set in step 102.

Step 108 produces data like that shown in FIG. 5 where the measure resolution is plotted against the voltage set on the focal plane correction electrode 25. Any suitable technique such as curve fitting may be used to find the optimum resolution at 110 and the corresponding voltage at 112. The voltage determined at step 112 may then be applied to the focal plane correction electrode 25 during subsequent operation, as shown at step 114.

This calibration method 100 shown in FIG. 4 may be repeated for different modes of operation, such as for a zoom mode as well as a regular mode. For example, a zoom mode may be used for an MS/MS analysis of TMT-labelled peptides. On fragmentation, these analytes produce TMT reporter ions in multiple channels around m/z 130 and require >50K resolution to distinguish different reporter ions. Peptides of multiple samples are labelled with different TMT labels and injected together; thus it is important to be able to distinguish the isobaric labels from one another. The labelled peptides also produce peptide fragments across a wide mass range. A scan may be made in a regular mode for efficient peptide fragment measurement, and then a further scan may be made in a zoom mode for high resolution measurement of the difficult TMT reporter ions. To perform this involves two scans in quick succession with a shift in the focal plane position between them. The focal plane correction electrode 25 makes it easy to switch between the optimum voltages for the regular and zoom modes to maintain optimum resolution in both modes of operation.

A further mode of operation is made possible by using the focal plane correction electrode 25 to correct focal plane position. The zoom mode may be switched on and off so quickly that, within a single scan, the TMT reporter ions make multiple passes through the mass analyser 10 in zoom mode, whilst the peptide fragments make only one pass. This is very advantageous as it occurs within a single scan, wasting neither type of ion, but requires a very fast switch of the focal plane correction electrodes 25 within the scan, preferably after the last fragment ion has reached the ion detector 16.

It was explained above that the focal plane correction electrode 25 of FIG. 3 can be used in a tilted mirror mass analyser 10, like that shown in FIG. 1, by inserting an additional, focal plane electrode 25 in the space between the existing pair of ToF correction electrodes 24. Two further embodiments will now be described that do not require an additional electrode to act as the focal plane electrode 25: instead, both embodiments adapt the potentials set on existing electrodes so that the electrodes may then also function as focal plane correction electrodes 25.

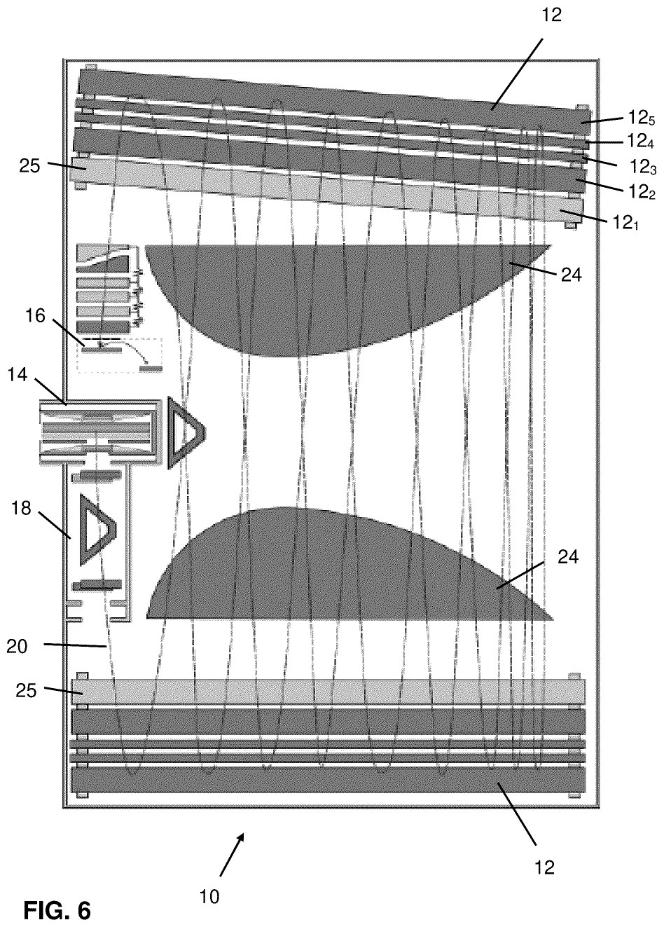

FIG. 6 shows a tilted mirror mass analyser 10, like that shown in FIG. 1, so common parts are not described to avoid repetition. As with the mass analyser 10 of FIG. 1, the mirror electrodes 12 are divided into a series of electrodes 12₁-12₅, each of which may be biased with a different electrical potential. Conventionally, the innermost electrode 12₁ of each mirror electrode 12 is grounded to provide a stable starting surface relative to the next electrode 12₂ which is set to a relatively high potential.

However, it has been realised that the innermost electrode 12₁ may be biased with a small potential away from ground without affecting operation of the mirror electrodes 12. Hence, the innermost electrodes 12₁ of each mirror electrode 12 may be used as focal plane correction electrodes 25 by setting the small potential required to correct the focal plane of the ion beam 20. Alternatively, the innermost electrode 12₁ of one mirror electrode 12 may be used as the focal plane correction electrode 25 while the innermost electrode 12₁ of the other mirror electrode 12 may be grounded. If the innermost electrodes 12₁ of both mirror electrodes 12 are used as focal plane correction electrodes 25 rather than the innermost electrode 12₁ of just one mirror electrode 12, a smaller potential is required for each innermost electrode 12₁ and symmetry is maintained for each ion beam oscillation between the mirror electrodes 12.

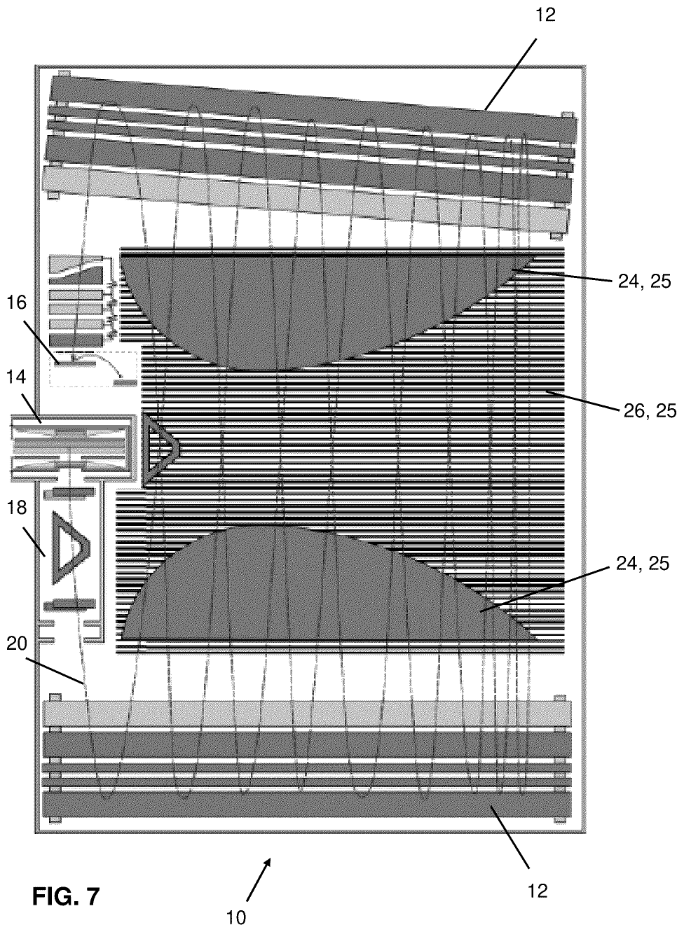

FIG. 7 shows a tilted mirror mass analyser 10, like those shown in FIGS. 1 and 6, so common parts are not described to avoid repetition. In practice, the ToF correction electrodes 24 may be supported by carriers 26 as shown in FIG. 7 (the carriers 26 are omitted from FIGS. 1 and 6 for the sake of clarity). In use, a potential is applied to the ToF correction electrodes 24 to effect the ToF correction such that a step in potential is introduced between the ToF correction electrodes 24 and their carrier 26.

It has been realised that the small potential required to correct the focal plane of the ion beam 20 may be added to the potential applied to the ToF correction electrode 24 such that the ToF correction electrode 24 also functions as the focal plane correction electrode 25. To ensure that the ToF correction electrode 24 still provides the required correction of the ToF of the ions 20, the step in potential between the ToF correction electrode 24 and its carrier 26 is maintained. Hence, the same potential required to correct the focal plane may be applied to both the ToF correction electrode 24 and its carrier 26. Consequently, in this embodiment, the combination of the ToF correction electrode 24 and its carrier 26 act as the focal plane correction electrode 25.

A person skilled in the art will appreciate that the above embodiments may be varied in many different respects without departing from the scope of the present invention that is defined by the appended claims.

Another possible improvement using focal plane correction with the focal plane correction electrode 25 is that of making a variable correction for different m/z ions. This might be accomplished, for example, by applying a time-dependent voltage to the focal plane correction electrode 25 so that the average voltage seen by ions 20 with different m/z ratios changes as lower m/z ions leave the mass analyser 10 before higher m/z ions. This may provide at least some compensation of mass dependent variations in ion energy, as is known to be induced by extraction traps.

A special case arises when an RF frequency is applied to the focal plane correction electrode 25, and then with a controlled frequency and phase may bring an m/z range into resonance, potentially allowing compensation of m/z regions known to be under space charge effects.

Certain proposed forms of extraction traps, such as extraction from an RF carpet have a disadvantage of producing a very m/z dependent focal plane position. The focal plane correction electrode 25 can be used to correct this m/z dependency by applying a small-time dependency in its applied voltage.

1. A method of mass spectrometry in a multi-reflection time of flight mass spectrometer comprising a mass analyser with two mirror electrodes and a focal plane correction electrode, wherein each mirror electrode is elongated generally along a drift direction (y), each mirror electrode opposing the other in a z direction, the z direction being orthogonal to y, and the focal plane correction electrode extends along at least a portion of the drift direction in or adjacent a space between the mirror electrodes, the method comprising:
injecting ions into the mirror electrodes and providing an electrical potential to the mirror electrodes that reflects the ions in the resulting ion beam and causes the ions to follow a zig zag path as they drift along the mirror electrodes; and
providing an electrical potential to the focal plane correction electrode to set a focal plane position of the ion beam to coincide with a detector surface of an ion detector placed at the end of the ions' path through the mirror electrodes.

2. The method of claim 1, comprising providing the electrical potential to the focal plane correction electrode to set an effective length of the ions' oscillations between the mirror electrodes such that the total effective path length of the ions causes the focal plane position of the ion beam to coincide with the detector surface of the ion detector.

3. The method of claim 1, comprising adjusting the electrical potential provided to the focal plane correction electrode during a scan to mitigate the drift of the focal plane position of the ion beam away from the detector surface of the ion detector.

4. The method of claim 3, comprising adjusting the electrical potential to the focal correction electrode during a scan to mitigate the drift of the focal plane position of the ion beam away from the detector surface of the ion detector as a function of the number of ions in the mass analyser.

5. The method of claim 3, wherein the scan comprises a part where the mass analyser is not operating in zoom mode and another part where the mass analyser is operating in zoom mode.

6. The method of claim 3, wherein the mass analyser is operating in zoom mode with a first part where the ions make a first number of passes up and down the mass analyser and a second part where the ions make a second number of passes up and down the mass analyser, wherein the first and second numbers are not the same.

7. The method of claim 1, comprising adjusting the electrical potential provided to the focal plane correction electrode between scans to mitigate the drift of the focal plane position of the ion beam away from the detector surface of the ion detector.

8. The method of claim 7, comprising adjusting the electrical potential to the focal plane correction electrode between scans to mitigate the drift of the focal plane position of the ion beam away from the detector surface of the ion detector as a function of the number of ions in the mass analyser.

9. The method of claim 7, wherein the scans comprise a first scan and a second scan where the first scan is not a zoom mode scan and the second scan is a zoom mode scan.

10. The method of claim 7, wherein the scans comprise a first scan and a second scan, wherein the first scan is a zoom mode scan where the ions make a first number of passes up and down the mass analyser and the second scan is a zoom mode scan the ions make a second number of passes up and down the mass analyser, wherein the first and second numbers are not the same.

11. The method of claim 1, comprising providing the electrical potential to the focal plane correction electrode with a value between ±150 V.

12. The method of claim 1, wherein:
the mirror electrodes are segmented into electrodes that extend in the y direction and are separated in the z direction; and
providing the electrical potential to the focal plane correction electrode comprises providing the electrical potential to the electrode of one or both the mirror electrodes closest to the space between the mirror electrodes.

13. The method of claim 1, wherein:
the mirror electrodes are tilted at a tilt angle relative to one another such that the separation between the mirrors in the z direction decreases as the distance along the y direction increases;
the mass analyser further comprises a time of flight correction electrode;
the method further comprises providing a further electrical potential to the time of flight correction electrode to correct a spread in the time of flight of ions along ions' path through the mirror electrodes caused by the tilt angle of the mirror electrodes; and
providing the electrical potential to the focal plane correction electrode comprises providing the electrical potential and the further electrical potential to the time of flight correction electrode.

14. The method of claim 13, wherein:
the time of flight correction electrode is supported by a carrier; and
providing the electrical potential to the focal plane correction electrode comprises providing the electrical potential and the further electrical potential to the time of flight correction electrode and providing the electrical potential to the carrier.

15. A method of calibrating a mass analyser in a multi-reflection time of flight mass spectrometer, wherein the mass analyser comprises two mirror electrodes and a focal plane correction electrode, each mirror electrode being elongated generally along a drift direction (y), each mirror electrode opposing the other in a z direction, the z direction being orthogonal to y, and the focal plane correction electrode extending along at least a portion of the drift direction in or adjacent the space between the mirror electrodes, the method comprising:
injecting ions into the mirror electrodes and providing an electrical potential to the mirror electrodes that reflects the ions in the resulting ion beam and causes the ions to follow a zig zag path as they drift along the mirror electrodes;
providing a range of electrical potentials to the focal plane correction electrode;
detecting ions with a detector surface of an ion detector placed at the end of the ions' path through the mirror electrodes; and
measuring the resolution of the mass analyser at each of a plurality of electrical potentials provided to the focal plane correction electrode.

16. The method of claim 15, wherein measuring the resolution of the mass analyser at each of a plurality of electrical potentials provided to the focal plane correction electrode comprises measuring the width of a peak corresponding to number of ions as a function of the ions' m/z ratio.

17. A multi-reflection time of flight mass analyser comprising:
two mirror electrodes, each mirror electrode elongated generally along a drift direction away from an ion injection point (y direction), each mirror electrode opposing the other in a z direction, the z direction being orthogonal to the y direction;
a focal plane correction electrode extending along at least a portion of the Y direction in or adjacent the space between the mirror electrodes; and
a controller configured to cause the mass analyser to operate in accordance with a method comprising,
injecting ions into the mirror electrodes and providing an electrical potential to the mirror electrodes that reflects the ions in the resulting ion beam and causes the ions to follow a zig zag path as they drift along the mirror electrodes, and
providing an electrical potential to the focal plane correction electrode to set the focal plane position of the ion beam to coincide with a detector surface of an ion detector placed at the end of the ions' path through the mirror electrodes.

18. The multi-reflection time of flight mass analyser of claim 17, wherein the two mirror electrodes are tilted at a tilt angle relative to one another such that the separation between the mirrors in the Z direction decreases as the distance along the Y direction increases.

19. The multi-reflection time of flight mass analyser of claim 17, wherein the width of the focal plane correction electrode is substantially the same in the Z direction along the length of the focal plane correction electrode in the Y direction.

20. The multi-reflection time of flight mass analyser of claim 17, comprising a pair of focal plane correction electrodes placed on opposing sides of the ion beam's path through the mass analyser.
